(19) United States
(12) Patent Application Publication
(10) Pub. No.: US 2008/0059785 A1
(43) Pub. Date: Mar. 6, 2008

(54) METHOD AND APPARATUS FOR SHUTTING DOWN A COMPUTER SYSTEM

(75) Inventor: Daniel James O'Connell, Auckland (NZ)

Correspondence Address: YOUNG & THOMPSON, 745 SOUTH 23RD STREET, 2ND FLOOR, ARLINGTON, VA, 22202, US

(73) Assignee: TI TECHNOLOGIES LIMITED, NORTH SHORE CITY (NZ)

(21) Appl. No.: 11/928,081

(22) Filed: Oct. 30, 2007

Related U.S. Application Data
(63) Continuation-in-part of application No. 10/891,149, filed on Jul. 15, 2004, now Pat. No. 7,313,684.
(63) Continuation-in-part of application No. 10/266,694, filed on Oct. 9, 2002, now abandoned.

(30) Foreign Application Priority Data
Aug. 14, 2002 (NZ) 520786

(51) Int. Cl. G06F 15/177; G06F 12/06

(52) U.S. Cl. 713/2; 711/103; 711/E12.008

(57) ABSTRACT

A method for quickly shutting down a personal computer system using a non-volatile reprogrammable memory device. A compressed memory image of the contents of the system working memory, hardware configuration and other relevant information is stored in the non-volatile reprogrammable memory. When shutting down, the process detects changed hardware and diverts from the immediate shut down to identify the changed hardware and create a new memory image before completing the shut down.

### CROSS REFERENCE TO RELATED APPLICATIONS

This application is a continuation-in-part of co-pending application Ser. No. 10/891149, filed on Jul. 15, 2004, which in turn is a continuation-in-part of application Ser. No. 10/266,694. It claims priority to New Zealand Application 520786, filed on Aug. 14, 2002. The entire contents of each of the above identified applications are hereby incorporated by reference.

### FIELD OF THE INVENTION

This invention relates to the shut down of a computer system or other digital processing device, and includes both a “soft off” and a “hard off” where all power is turned off. It has particular relevance to desktop computer systems and personal computers including mobile computing devices.

### BACKGROUND OF THE INVENTION

From a cold or hard boot the first program that a personal computer typically runs is a set of instructions loaded in Read Only Memory (ROM) or Electrically Erasable Read Only Memory (EEPROM) which contains the information required to initialize the system hardware and enable the machine to activate a hard disk drive to find the boot-strap loader.

Therefore, at present, operating systems load boot information and files from the local hard disk drive into the working or system memory, commonly called Random Access Memory (RAM). This information usually includes file system drivers, the operating system kernel, and con-figuration and device information that have to be parsed into useful information, and general cosmetic customizations.

Because of the sheer number and size of these files, computers often take several minutes to either shut down or to boot i.e. to get to a useable state, which end users often find very frustrating.

The time taken to shut down or boot a personal computer can have a significant impact on worker productivity. Personal computers are widely used in workplaces, particularly in office environments. In a large office the time spent waiting for computers to boot can result in a large quantity of unproductive time. If personnel are using mobile personal computers which are taken to meetings throughout the working day, then the problem is magnified.

Moreover the time taken to shut down or to boot computers means that they are often left on when not being used, thereby wasting power.

Furthermore, it is not uncommon to have to re-boot a personal computer due to an operating system error that simply occurs as a result of use of the computer.

Furthermore, in some environments the continuing functionality of a computer system or other digital processing device can be very important, for example the control of a communication system or a production process. Therefore, down time resulting from a system failure or “crash” must be kept to a minimum.

The Advanced Configuration and Power Interface (ACPI) specification enables boot times to be reduced, but even systems that implement this specification usually require users to wait at least 30 seconds before they can use their computers.

To achieve this it is known to provide an “image” of the booted computer memory and to store this to hard disk or in memory as in U.S. Pat. No. 6,446,203. This patent specification still requires that the operating system be booted sufficiently to identify the area of the disk to be read, and it provides no security for the image, nor any provision for changing the image, nor any reference to storing other than the working memory.

US application 2002/0078338 stores a boot image in secondary memory, and boots from this if detected, however it has no security and is unable to detect changes in configuration.

US application 200110039612 provides a boot image in memory at power down but has no provision for security of the image, nor does it appear to require more than the working memory to be stored.

US application 20002/0169950 provides a boot image of the initial boot process and a compressed boot image of the middle part as well as providing a copyright check on the initial boot image, but has no other apparent security or hardware check.

WO 01113221 uses a ROM to store a boot image, including user programs but has no apparent security, although it does store a compressed OS on disk.

U.S. Pat. No. 7,167,3417 provides a boot image stored on hard disk in compressed state, but updated for configuration changes. It has no apparent security or hard-ware check.

It is therefore an additional problem with a computer storing an image which boots on power up that there is held in the computer an insecure version of the booted computer memory data, possibly including data held securely elsewhere. This therefore would allow extraction of the memory image to be one means of bypassing whatever security is involved in the normal booting process.

Still further, it is possible that hardware on the computer has changed while the computer was switched off. In such cases the computer either recognizes that the hardware has changed, and abandons the boot image for a full boot, or fails to recognize that changes have occurred and attempts to boot normally. Both courses will result in extended boot periods.

### OBJECT OF THE INVENTION

It is an object of the present invention to provide a method and apparatus for initiating a shutdown of a computer to a state from which it may be repeatedly rebooted which will reduce the time required for existing systems to shut down whilst providing a secure environment for data stored within the computer memory.

It is a further object of the present invention to provide measures which will allow changes in the configuration of the computer system to be stored prior to shut down.

These objects of the present invention will at least go some way toward overcoming disadvantages of the prior art, or will provide the public with a useful choice.

### SUMMARY OF THE INVENTION

In one aspect the invention provides a method of initiating a shutdown of a computer to a state from which it may be repeatedly rebooted, in which the computer has at least one central processing unit (CPU), a loaded operating system, a system working memory and non-volatile reprogrammable memory, the method comprising:
maintaining prior to shut down in non-volatile reprogrammable memory a stored image of at least the current system working memory, the computer hardware configuration and context information and the CPU register content, varying the stored image if the hardware information or context has changed;
maintaining prior to shut down in non-volatile reprogrammable memory a stored image of at least the current system working memory, the computer hardware configuration and context information and the CPU register content, varying the stored image if the hardware information or context has changed;
on a shutdown request forthwith powering down the machine without individually closing down each software process.

Preferably any chipset registers are additionally saved to the stored image.

Preferably the saved memory image is saved in a compressed form.

Preferably the saved memory image also includes volatile page file memory at the time when current saved memory image was created.

Preferably the saved memory image is first created at the time of the first boot of the machine.

Preferably it includes the step of encrypting and compressing the memory image and storing the encrypted compressed memory image into the non-volatile reprogrammable memory.

Preferably the maintaining step includes the step of archiving the last known good memory image to an appropriate storage means and the memory image that was created at the previous shut down would be marked as the last known good memory image.

Preferably where no changes to a memory image are required at shutdown, no system configuration changes are saved.

Preferably the non-volatile reprogrammable memory is flash memory and the method includes the step of modifying the operating system source code to support a flash file system and/or a Flash Translation Layer (FTL).

Preferably the created memory image is an image including all system settings and memory contents relating to a logged in user.

In another aspect the invention provides a computer system capable of providing an abbreviated shut down including:
a digital processing means,
a working memory for the digital processing means,
a non-volatile reprogrammable memory
a memory image stored in the non-volatile reprogrammable memory of desired contents of the system working memory and other portions of memory created before shutting down and sufficient to provide rebooting of the computer to a working state,
the memory image including at least an image of the system working memory, the computer hardware configuration and context information and the CPU register content maintained as they were prior to the last request for shutdown, the image having been varied to include any changes in hardware configuration.

Preferably the system includes a disk drive or other memory storage device including at least one archive copy of the memory image.

Preferably the system includes a disk drive or other memory storage device including at least one “last known good” copy of the memory image.

Preferably the non-volatile reprogrammable memory uses Flash memory.

### BRIEF DESCRIPTION OF THE DRAWINGS

FIG. 1 is a flow diagram of a computer boot or start-up process according to the invention for an operating system driven computer

FIG. 2 is a flow diagram of a computer boot or start-up process according to the invention for a firmware driven computer

FIG. 3 is a flow diagram of a shutdown process according to the invention

FIG. 4 is a flow diagram of a shutdown process for a firmware driven computer according to the invention.

FIG. 5 is a diagram of the contents of a compressed memory image file

FIG. 6 is a flow diagram of the swap operations involved in paging data between the various memory or virtual memory locations.

FIG. 7 is a diagram of the data flow within the computer

### DETAILED DESCRIPTION

The examples referred to below relate to use of the invention to shut down or boot a personal computer and to a personal computer having a non-volatile reprogrammable memory configured to effect booting the computer. However, the invention is also applicable to other digital processing devices which require an operating system to be loaded for use, for example computer game machines, business machines and telecommunication apparatus.

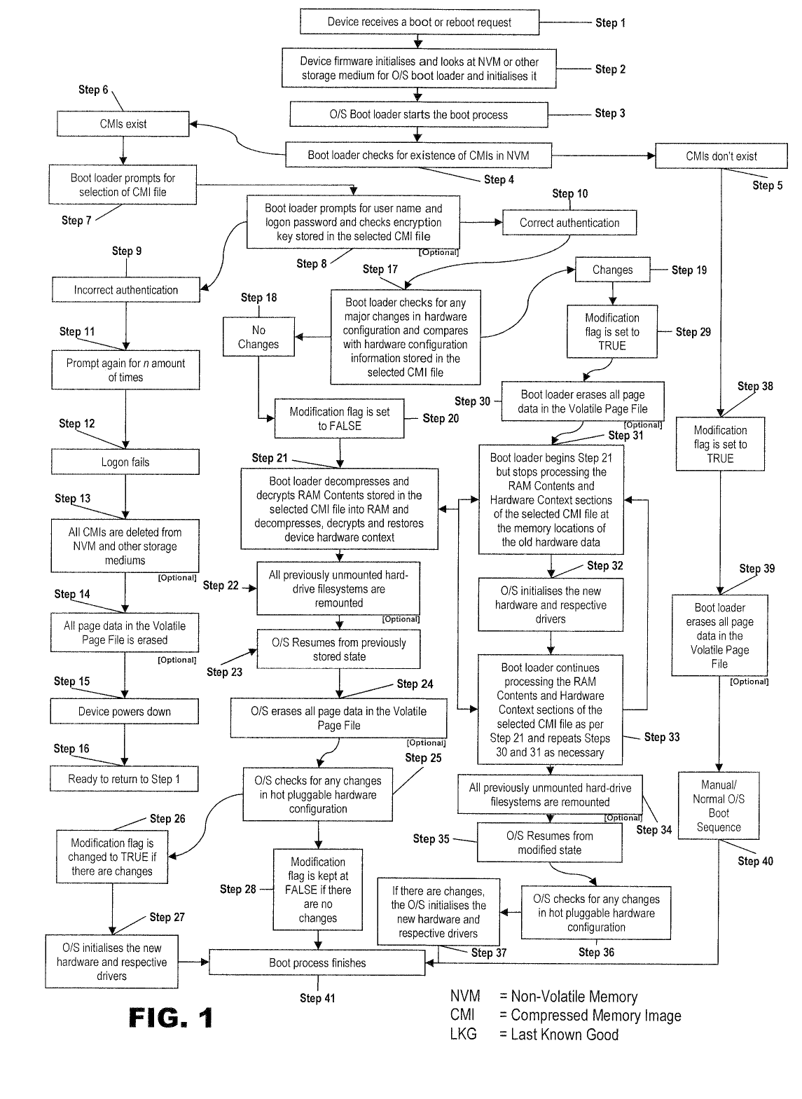

Referring to FIG. 1, a flow diagram of a boot or start up process for a computer system according to the invention is illustrated.

The method described with reference to FIG. 1 assumes that a “cold” or “hard” boot is being performed. Those skilled in the art will see that the method is also applicable to situations where a “warm” or “soft” boot is performed.

Referring to FIG. 1, a user activates the system power button for example in step 1. This applies power to the system and, in the usual way; the firmware software initiates the boot sequence. Therefore in step 2, the firmware is activated, performs its usual POST initialization sequence, and then does one of two things. The firmware either: a) looks to the hard drive of the system for the operating system boot loader, as occurs in existing boot sequences; or (b) alternatively, the firmware looks to a non-volatile reprogrammable memory provided in the computer system. Even if the firmware initially looks to the hard drive for the operating system boot loader, the boot loader still directs the system to download a memory image from the non-volatile reprogrammable memory, as will be described further below, though this may be conditional on the user entering a password stored in firmware.

The non-volatile reprogrammable memory is typically provided as an integrated circuit, which is accessible to the computer system, for example being provided on the motherboard of the personal computer. Alternatively, it is provided as a PCI add-in card to retrofit to an existing machine. The non-volatile reprogrammable memory may also be provided in other ways, so long as it satisfies requirements of being accessible to the system to enable its contents to be accessed sufficiently quickly by the system to make the boot method of the present invention worthwhile.

Turning now to step 3, the operating system boot loader therefore starts the boot process either directly from the contents of the non-volatile reprogrammable memory, or from the hard drive of the system and then checks for the existence of any CMIs at step 4.

The non-volatile reprogrammable memory contains a memory image of the contents of RAM which are sufficient, when loaded into system memory, to enable the computer system to be provided in a useable state for a user i.e. to boot the computer system.

Depending upon the requirements of the user, the memory image that is captured and provided in the non-volatile reprogrammable memory may take a variety of forms. For example, the non-volatile reprogrammable memory may contain a memory image of the post-boot system working memory (i.e. RAM) contents.

Another alternative, for example, is to load the non-volatile reprogrammable memory with a preferably compressed memory image of all data currently stored in RAM. In a preferred form, this compressed memory image is stored from a previous shutdown procedure similar to a State S4 shutdown procedure in the current ACPI 2.0a specifications. This includes computer and/or operating system settings of the computer system where it is in a state ready for use by a user, and is preferably provided to a user for a user to resume use of the system where it is in a condition which is the same or substantially the same as it was when the user commenced shutdown.

Details of a standard ACPI S4 shutdown can be found from the current ACPI specification, Revision 2.0, which is available at url http://www.acpi.info.

The memory image may also be only a partial image of the system memory. Therefore, the image may comprise data relating to the bulk of the operating system for example, and the remainder of the information necessary to build or establish the system working memory may be loaded into the working memory from another memory storage device such as the system hard disk. This arrangement may be preferable where the size of the non-volatile reprogrammable memory needs to be limited, for example due to cost constraints, but the invention is still worthwhile because the overall time taken to perform a boot process is still significantly reduced as compared to known boot processes.

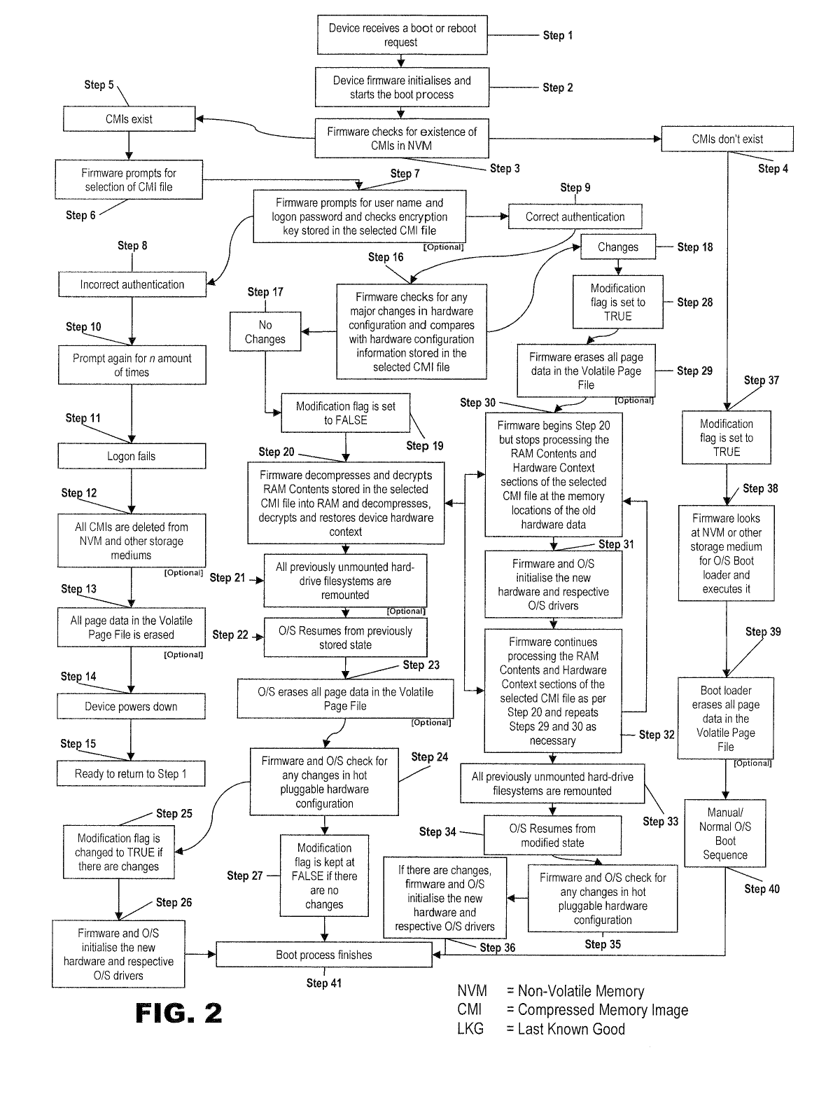

The memory image may be initially created during the set up process of the operating system, or may alternatively be replaced whenever a user makes a significant change to the configuration of the computer. Also, the memory image may be captured every time the user initiates a shut down sequence. These options are discussed further with reference to FIG. 2.

The memory image is preferably compressed, so that a compressed memory image (CMI) is stored in the non-volatile reprogrammable memory and retrieved from the non-volatile reprogrammable memory when required. Compression can save a significant amount of memory space without the decompression process adding significantly to the reduced boot time provided by the present invention. A compression algorithm such as that available in the open source zlib library may be used.

In addition to compression the memory image may also be encrypted to the same standard as the hard drive to prevent attempts to recover information from the memory where the hard drive carrying the same data is secured.

In FIG. 1, where it has been determined that a compressed memory image exists (step 6), the user is required to choose (step 7) among CMI files if there are multiple files (as, for instance, for multiple users or different operating systems) and is prompted for a password (step 8). If an incorrect password is supplied (step 9) the logon attempt may be retried (step 11) but if it eventually fails (step 12) the computer deletes the compressed memory image (step 13), optionally deleting all saved CMI's, and any data in the volatile page file (the temporary storage on the hard disk) and shuts down (step 15) in preparation for another boot attempt (Step 16). These precautions render it difficult to break the fast boot system. If the CMI is deleted the next boot will be a normal boot sequence (steps 4-5, 36-39).

When a password is supplied and correct the boot loader checks for any major changes in hardware from that of the compressed memory image (step 17). If there are none at step 18 the modification flag is set to FALSE at step 20 and the CMI located in the non-volatile reprogrammable memory is decompressed, and the computer system settings and full memory contents are loaded into RAM from the decompressed CMI (step 21), thus providing all the applications, services and device drivers. Following this any known and unmounted file systems may optionally be remounted at step 22.

The operating system then takes over from the previously stored state (step 23), optionally clears the volatile page file (step 24) and checks for any changes in the hot pluggable hardware configuration at step 25. Where changes are found the modification flag is reset at step 26 to TRUE and the operating system initializes the new hardware at step 27 before the boot process finishes at step 41. If no changes are found the flag remains set to FALSE and again the boot process finishes at step 41.

The quicker boot process is now completed.

If a changed hardware configuration is found at the hardware check (step 17) the boot loader notes this at step 19, sets the modification flag to TRUE at step 29 and then clears all temporary data (step 30). At step 31 begins the decompression and decryption as at step 21 but processes the memory image only to the point where the hardware change needs servicing. At this point step 32 is invoked to initialize the new hardware and any required drivers before continuing. The memory image decompression and loading is then resumed, jumping over the inapplicable portion (step 33). After this optionally any unmounted file systems are mounted at step 34, the operating system is resumed at step 35 and any changes in the hot pluggable hardware configuration detected at step 36 for initialization at step 37 before again finishing at step 41. The OS is thus instantiated and the PC boots fully, as previously, however the modification flag will be set so that a new memory image will be saved at shut down.

Where no CMIs are found at step 4 the system diverts to step 5, sets the modification flag to TRUE at step 38, optionally deletes the entire contents of the volatile page file at step 39 and invokes the normal operating system boot sequence.

Because the memory contents are loaded very quickly from the non-volatile reprogrammable memory into RAM, rather than being searched for and transferred from the system hard disk, the time required for the boot process is dramatically reduced.

In one example of booting a personal computer (PC) using the Microsoft Windows™ operating system, the firmware checks the non-volatile reprogrammable memory for boot information first, and loads the windows boot files and kernel into memory. The registry hives may be created and stored in non-volatile reprogrammable memory if storage space permits, or they may be created and stored on the local hard drive, as is the case with existing systems. While Windows is loading, device drivers will be loaded into RAM from non-volatile reprogrammable memory. Services and third party start-up applications will be preloaded from the local hard drive. A typical personal computer may be physically modified to implement this process by providing 64 megabyte or upwards of non-volatile reprogrammable memory chip(s) added to the motherboard of the machine. The firmware on the PC is modified to allow booting from the non-volatile reprogrammable memory using built in support for a flash file system (FFS) and Flash Translation Layer (FTL). Microsoft Windows™, for example Windows XP, may be modified to support the FFS/FTL through internal drivers (e.g. FAT16/32, NTFS, and FFS/FTL) or third party drivers. Hardware support can be provided through an add-on PCI based product. Windows boot files and device drivers are added to the non-volatile reprogrammable memory and third party start up programs are physically moved to the start of the hard drive.

In another example using a Windows operating system, the firmware boots from non-volatile reprogrammable memory, and loads and decompresses the memory image into RAM. Minor environmental changes are loaded or created from the beginning of the hard drive after the memory image is in RAM. These include (but are not limited to) the following:
Application installations
Non-critical start-up applications
Registry hives
Page file (virtual memory).

Physical modifications to a typical personal computer running Microsoft Windows operating system are similar to those referred to in the example above, however a user customized compressed Windows memory image is created during Windows setup, and is stored in non-volatile reprogrammable memory. Further customized settings are stored at the beginning of the hard drive.

FIG. 2 shows an alternative sequence for those computers which use a firmware which checks for component changes. This sequence differs from that of FIG. 1 only in that the BIOS performs the hardware configuration checks rather than using an operating system which provides the checks.

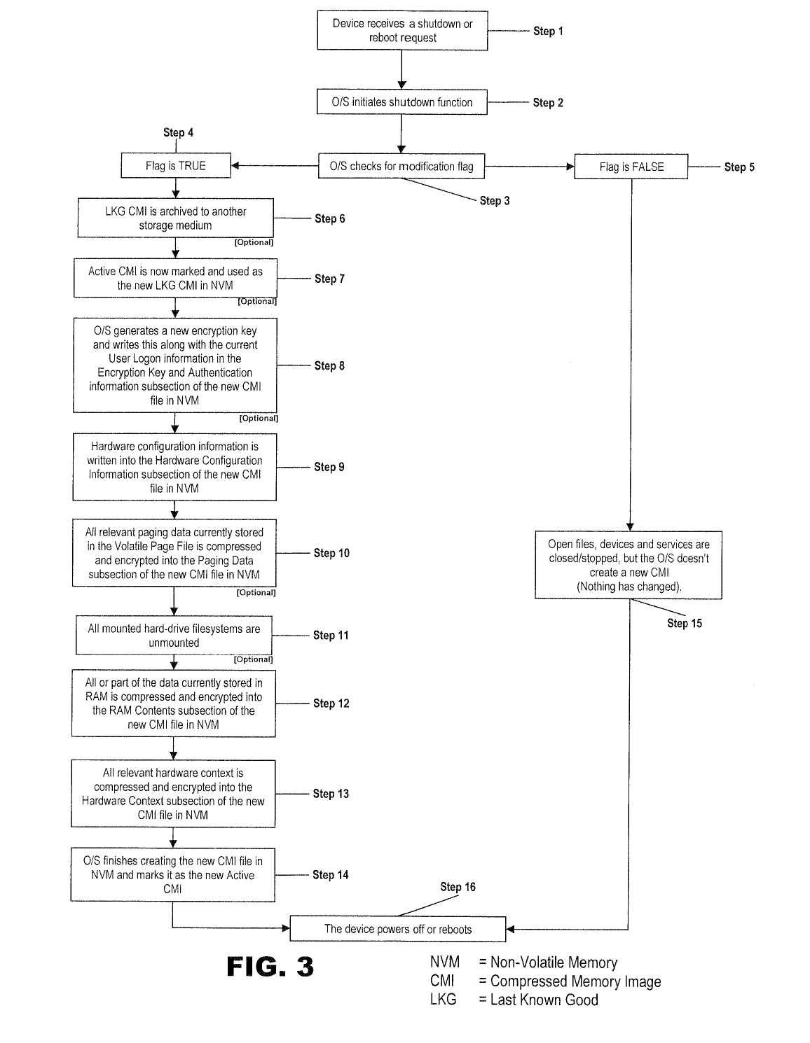

Turning now to FIG. 3, a shut down process for a computer system according to the invention is diagrammatically illustrated. The process begins in step 1 with the user selecting a shut down command from the operating system requiring the operating system to initiate a shutdown function at step 2. The operating system, as part of the shut down process, then checks for a modification flag in step 3. The modification flag is one that is set by the operating system whenever a significant change is made to the configuration of the computer. A significant change may include (without limitation) the following:
a) new application installations
   i) application installations that require components to load once the operating system boots.
b) changes to registry hives
c) device driver upgrades
d) service pack/hotfix installations
e) service modifications
f) user environment customizations
   (i) desktop
   (ii) wallpaper
   (iii) themes
   (iv) sounds
   (v) icons
   (vi) color schemes.

Therefore, with each new user session from a boot up the modification flag is set to false. Then, when a significant change occurs, such as changes listed above for example, then the flag is set to true. For purposes of clarity, the list of significant changes provided above is not exhaustive. Furthermore, a user may wish to exclude some of the actions from the list provided above.

Returning to FIG. 3, if the modification flag is false as shown in step 5, then the operating system closes all open files, devices and services but does not save any system configuration data, since nothing in that area has changed, as shown in step 15. The operating system then continues its normal shut down process, currently implemented in the ACPI 2.0a specifications as a State S5 Shutdown, in step 16. In achieving this state the computer rapidly clears the system disk caches and closes down all systems except those which may be needed to externally activate the computer again, such as the power button and a “wake on LAN” network connection detection. The computer is then in a state where it may either be switched off or reboot. This allows a fast shut down as it is an abbreviated shut down compared to the normal shut down process of a computer running a Windows based operating system.

If the modification flag is true as shown by step 4 in FIG. 3, then the “last known good” (LKG) compressed memory image is archived to an appropriate storage means such as the system's local hard drive. This occurs in step 6.

Then, in step 7, the CMI that was used to last boot the system, being the active CMI, is now used as the LKG CMI.

The operating system then initiates a modified shut down procedure, beginning with step 8.

In step 8 a new encryption key is generated and stored in a new CMI. Subsequent to this at step 9 the current hardware information is written to the new file. At step 10 the paging data in the volatile page file is optionally compressed and encrypted into the paging data section of the new CMI, at step 11 any mounted and unmountable file systems are unmounted and then at step 12 all data currently stored in RAM is compressed and encrypted using an appropriate compression algorithm and stored. File systems should be unmounted during creation of the CMI where a deletable file has any likelihood of being incorporated within the memory image since changes in such a file may cause indeterminate effects in a computer booted from the image. Next, the current hardware context is loaded at step 13. The loading process then completes and the final file in non-volatile RAM is marked as the new Active CMI at step 14. The operating system then finishes the modified shut down process as described above with reference to step 16.

From the method shown in FIG. 3 it can be seen that an archive of compressed memory images which may be used to boot the system is retained. In this way, if a user makes a significant change which is deleterious to the operation of the machine i.e. is undesirable, or if the system crashes, a user will always have at least one compressed memory image from which the machine may be rebooted.

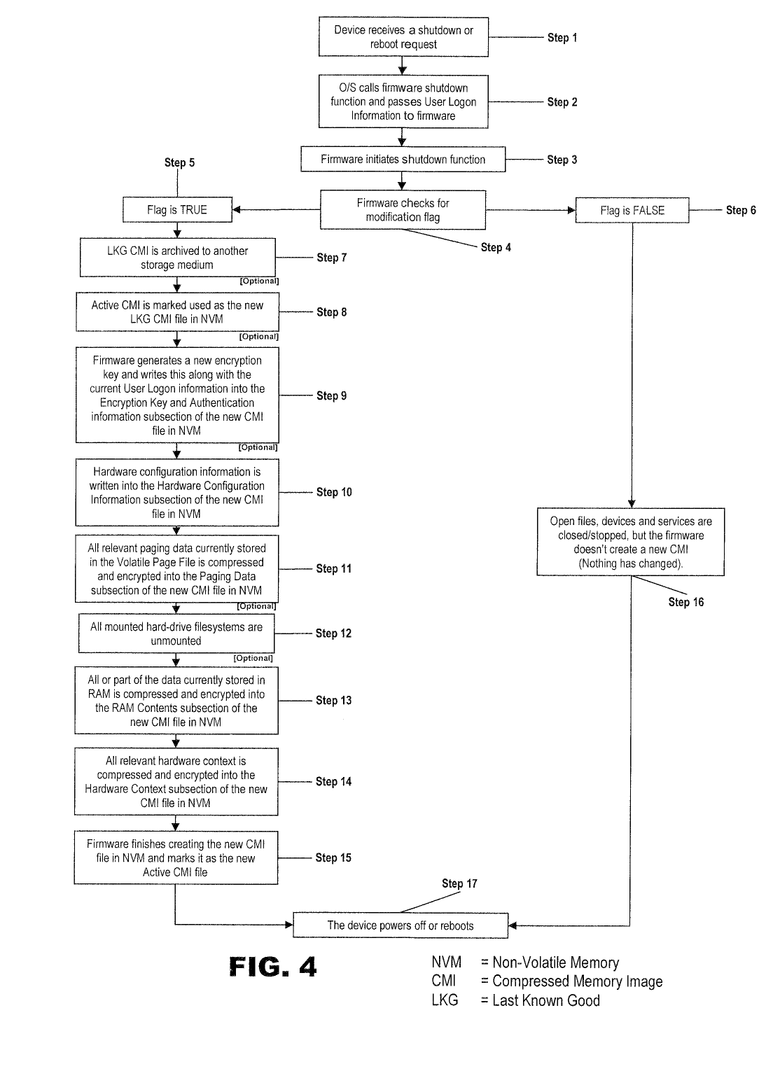

FIG. 4 shows a similar shutdown sequence to that of FIG. 3, but this time for a firmware controlled computer, where the initial and final parts of the modified shutdown procedure are under firmware control. The sequence differs in the handoff at step 2 by the operating system to the firmware, allowing the firmware to initiate the shutdown at step 3.

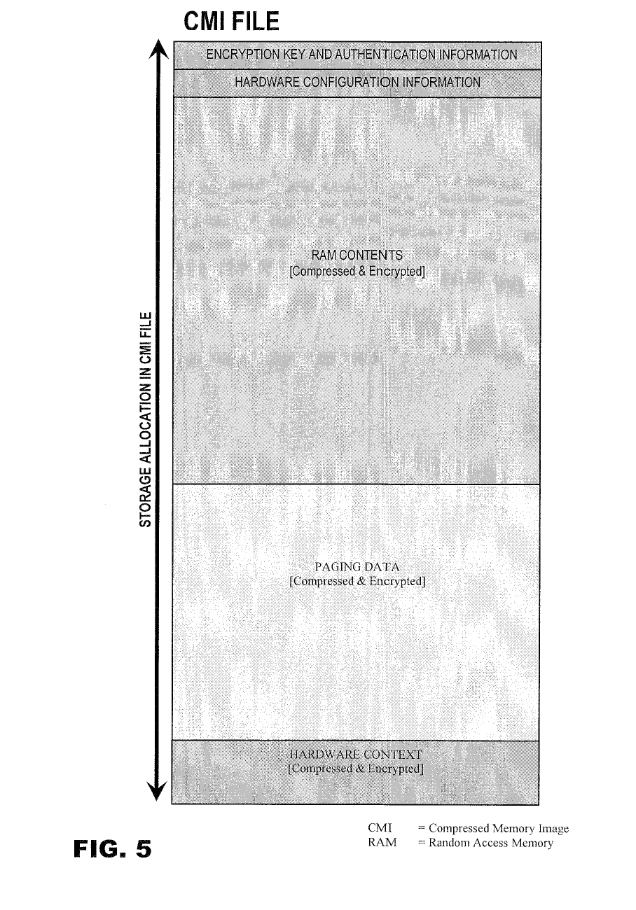

FIG. 5 shows the layout of a typical compressed memory image (CMI) file, where the encryption key and authentication information are stored first, followed by the hardware configuration information, then the RAM contents, the paging data from the virtual memory file (or volatile page contents) and finally the hardware context of the current hardware. The reloading of the compressed and encrypted information is sufficient to return the computer to a full working state if no changes have been made to its configuration since last shutdown.

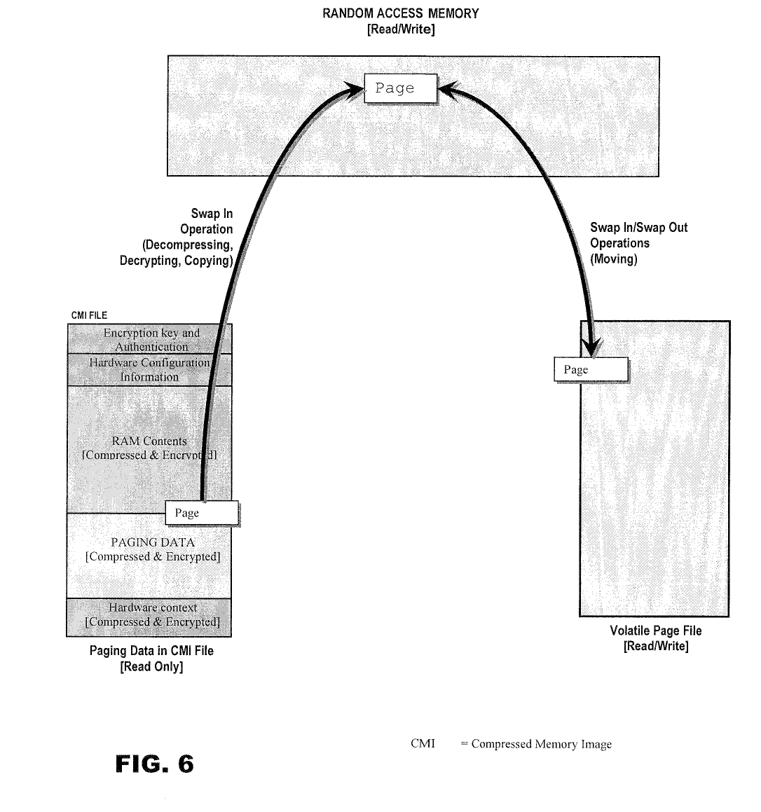

FIG. 6 shows the three operations relating to the storage of the paging files (volatile page file or virtual memory file) where these may have been stored in the compressed memory image. The first time the system requests a page (Step 1) which should be in the volatile page file it is retrieved from the CMI paging data, decompressed and decrypted before being exported to RAM as at step 2. If the page ages out in RAM, because pages with a higher priority must be stored, it will be swapped out to the volatile page file as at steps 3 and 4. Subsequently, as in normal operation, where the system again requests that memory page it will be swapped in from the volatile page file as shown by steps 5 and 6.

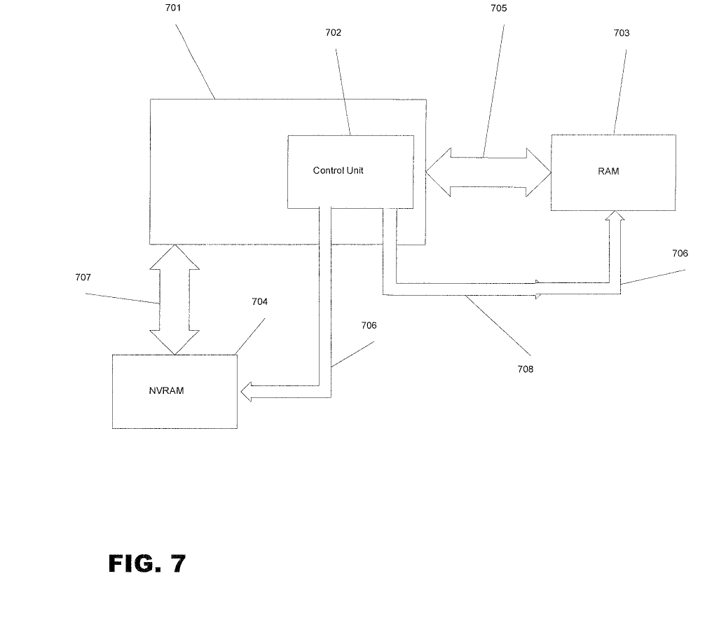

Turning now to FIG. 7, the basic processor and memory components of an example of a computer system according to the present invention are shown. To those skilled in the art to which the invention relates, other arrangements and communication paths for the memory devices are possible. The system has a central processing unit (CPU) 701 within which is provided a control unit 702. Working memory in the form of random access memory (RAM) 403 is provided, as is non-volatile reprogrammable memory 704. A data bus 705 allows data to be interchanged between RAM 703 and the CPU 701 under control of the control unit 702 via address data control bus 706. Similarly, a data bus 707 allows data to be interchanged between the non-volatile reprogrammable memory 703 and the CPU under control of the control unit 402 via address data control bus 708. Therefore, bus 707 allows information in RAM comprising the entire memory content to be transferred to non-volatile reprogrammable memory 704. Buses 705 and 707 may comprise a system bus. Furthermore, the content of RAM 703 may have been subject to compression whereby the compressed image may be transferred via bus 707 to be stored in non-volatile reprogrammable memory 704. Then, when required, the memory image stored in non-volatile reprogrammable memory 704 may be transferred directly to RAM 703, or may firstly be compressed and then installed in RAM 703.

The non-volatile reprogrammable memory 704 has the advantage that it is essentially a solid state device which is non-volatile so the contents of the non-volatile reprogrammable memory are retained when the power supply is removed from the computer system. However, those skilled in the art will appreciate that references in this document to non-volatile reprogrammable memory include the use of flash RAM i.e. the forms of non-volatile reprogrammable memory which require a source of external power such as a battery for example in order to maintain the memory content.

A non-volatile reprogrammable memory device according to the invention may be provided as an integrated circuit on the system motherboard for example, or on a separate board or card. In particular, if desired, non-volatile reprogrammable memory may be provided on a card such as those referred to under the trade marks SmartMedia or CompactFlash.

Some non-volatile reprogrammable memory products that are currently available have load times orders of magnitude faster than hard drives, so it will be seen that the method and system according to the present invention provides significant advantages in terms of boot times compared with prior art systems.

Other types of non-volatile memory and Solid State Disks may be used with or instead of Flash Memory, such as Magnetic RAM (MRAM) which boasts transfer speeds exponentially faster in both read and write operations than Flash Memory. MRAM was expected to be mass produced in 2005.

Preferably the set-up application for the desired operating system additionally creates a Compressed Memory Image (CMI), containing a compressed image of all data currently stored in RAM, such as is currently implemented in the ACPI 2.0a specifications (currently available from http://www.acpi.info as a State S4 system context file. This file is stored in the non-volatile reprogrammable memory, but the set-up application does not shut the computer down as is the case for a State S4 system context file creation in the current ACPI 2.0a specifications, rather it follows a programmed shut down procedure.

Preferably the operating system source code is modified to internally support a flash file system (FFS) through a Flash Translation Layer (FTL), such as Intel's own FTL specification (http://www.intel.com/design/ficomp/applnots/297816.htm).

Conveniently the compressed memory image (CMI) has the compressed version of all data currently stored in RAM resulting from a previous shut down procedure, similar to a State S4 shutdown procedure in the current ACPI 2.0a specifications.

In the most preferred embodiment the previous CMI is archived to non-volatile reprogrammable memory to be used as a “last known good” CMI.

References in this document to computer systems include digital data processing systems generally.

Throughout the description and claims of this specification the word “comprise” and variations of that word, such as “comprises” and “comprising”, are not intended to exclude other additives, components, integers or steps.

### INDUSTRIAL APPLICABILITY

The invention provides a method of allowing a computer to shut down considerably more quickly than a standard shut down, and repeatedly boot up from a stored memory image. It allows for greater productivity and security as computers can be shut down quickly when not needed (thereby encouraging power saving) and yet be booted up quickly and securely.

1. A method of initiating a shutdown of a computer to a state from which it may be repeatedly rebooted, in which the computer has at least one central processing unit (CPU), a loaded operating system, a system working memory and non-volatile reprogrammable memory, the method comprising:
maintaining prior to shut down in non-volatile reprogrammable memory a stored image of at least the current system working memory, the computer hardware configuration and context information and the CPU register content, varying the stored image if the hardware information or context has changed;
on a shutdown request, forthwith powering down the machine.

2. A method as claimed in claim 1 characterised in that any chipset registers are additionally saved to the stored image.

3. A method as claimed in claim 1 characterised in that the saved memory image is saved in a compressed form.

4. A method as claimed in claim 1 characterised in that the saved memory image also includes volatile page file memory at the time when current saved memory image was created.

5. A method as claimed in claim 1 characterised in that the saved memory image is first created at the time of the first boot of the machine.

6. A method as claimed in claim 1 characterised in that it includes the step of encrypting and compressing the memory image and storing the encrypted compressed memory image into the non-volatile reprogrammable memory.

7. A method as claimed in claim 1 characterized in that the maintaining step includes the step of archiving the last known good memory image to an appropriate storage means and the memory image that was created at the previous shut down would be marked as the last known good memory image.

8. A method as claimed in claim 1 characterized in that where no changes to a memory image are required at shutdown, no system configuration changes are saved.

9. A method as claimed in claim 1 characterized in that the non-volatile reprogrammable memory is flash memory and the method includes the step of modifying the operating system source code to support a flash file system and/or a Flash Translation Layer (FTL).

10. A method as claimed in claim 1 characterized in that the created memory image is an image including all system settings and memory contents relating to a logged in user.

11. A computer system capable of providing an abbreviated shut down including
a digital processing means,
a working memory for the digital processing means,
a non-volatile reprogrammable memory
a memory image stored in the non-volatile reprogrammable memory of desired contents of the system working memory and other portions of in memory created before shutting down and sufficient to provide rebooting of the computer to a working state,
the memory image including at least an image of the system working memory, the computer hardware configuration and context information and the CPU register content maintained as they were prior to the last request for shutdown, the image having been varied to include any changes in hardware configuration.

12. A computer system as claimed in claim 11 characterized in that the system includes a disk drive or other memory storage device including at least one archive copy of the memory image.

13. A computer system as claimed in claim 11 characterized in that the system includes a disk drive or other memory storage device including at least one last known good copy of the memory image.

14. A computer system as claimed in claim 11 characterized in that the non-volatile reprogrammable memory uses Flash memory.
